(19) United States
(12) Patent Application Publication
(10) Pub. No.: US 2005/0044903 A1
(43) Pub. Date: Mar. 3, 2005

(54) Lock mechanism

(76) Inventors: Renny Tse-Haw Ling, Taipei (TW); Chun-Sheng Wu, Taipei (TW); Cheng-Horng Wu, Taipei (TW)

Correspondence Address: BIRCH STEWART KOLASCH & BIRCH, PO BOX 747, FALLS CHURCH, VA, 22040-0747, US

(21) Appl. No.: 10/705,928

(22) Filed: Nov. 13, 2003

(30) Foreign Application Priority Data
Aug. 26, 2003 (TW) 092215426

(51) Int. Cl. E05B 37/02

(52) U.S. Cl. 70/30; 70/25

(57) ABSTRACT

A lock mechanism for latching a first object then coupling with a second object includes a case, a first shackle and a second shackle. The case includes a bolt assembly. The first shackle may be selectively coupled with the case to form a closed boundary with the case and latch the first object at a latch position, and unfasten the closed boundary at a release position. At the latch position, the first shackle is latched and anchored by the bolt assembly. The second shackle is movably mounted on the case and may latch the second object at a first position and release the second object at a second position.

### FIELD OF THE INVENTION

The invention relates to a lock mechanism for latching an object or coupling one object with another object to form a latched and inseparable connection.

### BACKGROUND OF THE INVENTION

A padlock for latching a guarded object is a product to protect the object from being stolen. Aiming at different guarding objects and functionality, many dedicated lock products have been developed, such as door locks, safe locks, bicycle locks, ski locks, and the like.

In the lock applications, there are also locks that have a built-in chamber such as those disclosed in U.S. Pat. Nos. 1,955,809, 4,838,052, 5,267,460 and 5,737,947. Depending on different usages, the chamber can contain required articles (such as keys, small tools, etc.). The lock has a lid that may be opened or closed and latched to keep the articles safely inside.

However, the chamber provided in those types of locks usually has a fixed housing compartment. The size and shape of the contained articles are restricted. While the chamber may be made bigger to overcome this problem, the entire lock becomes bulky and heavy.

Moreover, based on requirements, locks also are designed to couple with devices that have other functions, such as latching a compass, timer, or thermometer on a lock. The lock made to equip extra functions has more practical value. However, the attached devices on the lock are optional items that are usually made already, and consumers can only select suitable ones based on requirements. The selection is thus limited.

### SUMMARY OF THE INVENTION

In view of the aforesaid disadvantages, the primary object of the invention is to provide a lock mechanism that is able to couple with another functional object. The functional object may be broadly defined as an article equipped with practical functionality, or an article which has a housing compartment. The functional object may be separated from the lock mechanism or be coupled with the lock mechanism. Once coupled, it may be locked and become inseparable.

Accordingly, the lock mechanism of the invention may be used to lock a first object, then couple with and lock a second object. The lock mechanism includes a case containing a bolt assembly, a first shackle and a second shackle. The first shackle may be selectively coupled with the case, and form a closed boundary with the case at a latch position to lock a first object, and form a release position to open the closed boundary. At the latch position, the first shackle is fastened and anchored by the bolt assembly to maintain the latch position. The second shackle is movably mounted on the case and may be at a first position to latch the second object and at a second position to release the latch condition of the second object.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are sectional views of an embodiment of the lock mechanism of the invention in operating conditions.

FIGS. 2A and 2B are fragmentary schematic views of the invention showing the coupling interface of the lock mechanism and the second object.

FIG. 3 is a schematic view of the invention showing the lock mechanism coupled with a fixed second object.

FIG. 4 is a schematic view of the invention with a rigid shackle.

FIG. 5 is a schematic view of another embodiment of the invention coupled with a winch.

FIGS. 6A, 6B and 6C are schematic views of the invention according to FIG. 5 in operating conditions.

FIGS. 7A and 7B are sectional views of another embodiment of the lock mechanism of the invention in operating conditions.

FIG. 8 is a sectional view of still another embodiment of the invention.

FIGS. 9 and 10 are schematic views of the invention showing the linkage movement relationship between the actuating member and the second shackle.

FIG. 11 is a sectional view of another embodiment of the invention.

FIGS. 12A, 12B and 12C are schematic views of the invention showing the coupling movements between the case and the second object.

### DESCRIPTION OF THE PREFERRED EMBODIMENTS

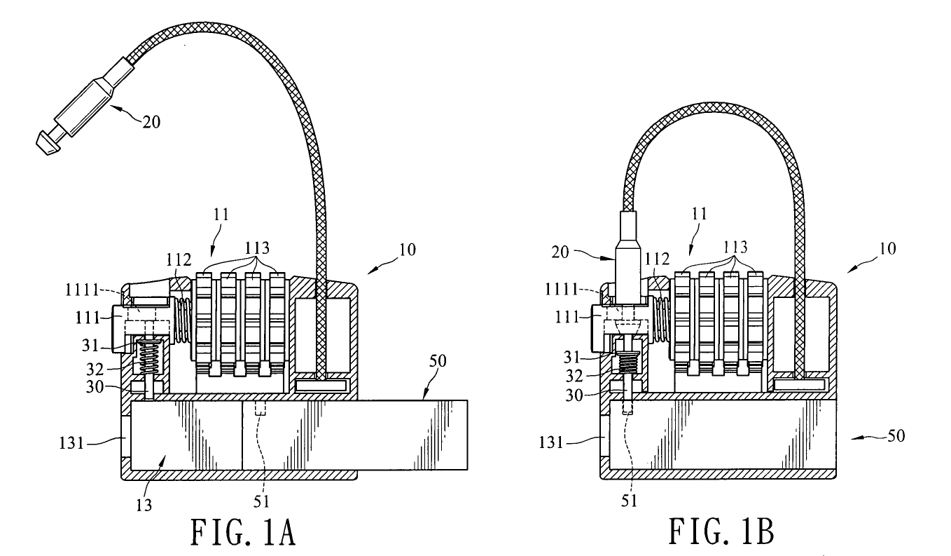

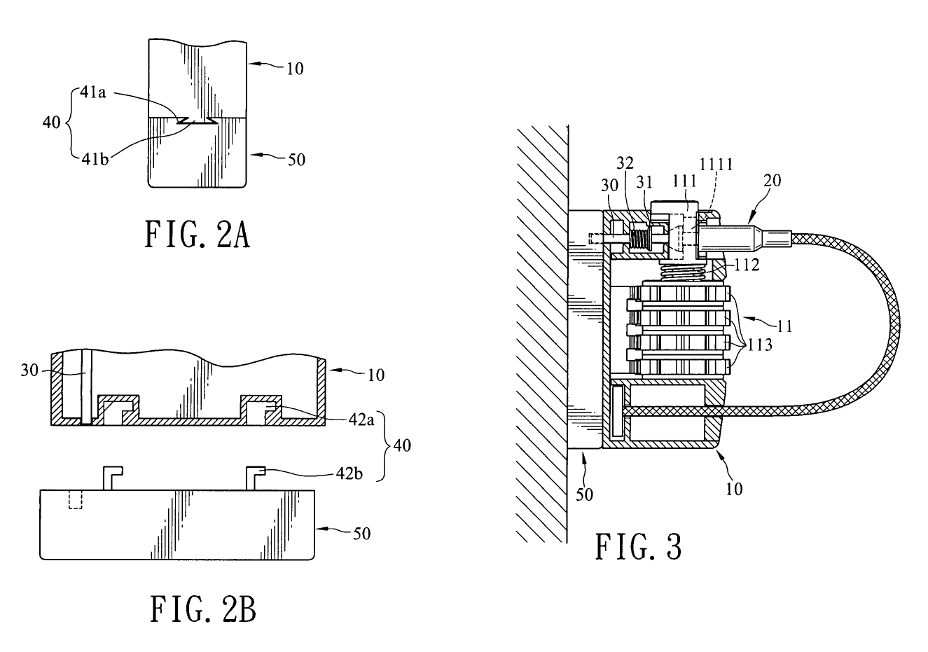

Refer to FIGS. 1A and 1B for a first embodiment of the invention. The lock mechanism includes a case 10, a first shackle 20 and a second shackle 30. The first shackle 20 and the case 10 may be coupled to form a closed boundary to latch on a guarded object that is fixedly positioned, such as a railing, desk leg, or the like. The case 10 may be coupled with an object that has a mating coupling interface, such as an object with a housing compartment (such as a tool box) or other objects equipped with desired functions (such as a thermometer, compass, and the like), or as shown in FIG. 3, a fixed object. It may further lock the object coupled on the case 10 through the second shackle 30. In order to avoid confusion, the guarded object locked by the first shackle 20 and the second shackle 30 is called the “first object,” namely the object to be locked by the first shackle 20, while a guarding object to be locked by the second shackle 30 on the case 10 is called the “second object 50.” Moreover, the coupling method of the second object 50 and the case 10 may include a cartridge trough 13 in the case 10 for housing the second object 50 in a sliding manner. In practice, the cartridge trough 13 may include an elastic element (not shown in the drawings) to eject the second object 50 from the cartridge trough 13, or an opening 131 may be formed on a side wall of the case 10 so that an external force may pass through the opening 131 to push the second object 50 out of the cartridge trough 13. Furthermore, the coupling of the case 10 and the second object 50 may also adopt an approach shown in FIGS. 2A and 2B in which the case 10 and the second object 50 have respectively a sliding trough 41a and a sliding track 41b, or a latch trough 42a and a latch hook 42b on the coupling sides.

As shown in the drawings, the case 10 has a bolt assembly 11 that includes combination rings 113, a movable strut 111 and an elastic element 112. The movable strut 111 has one end running through the combination rings 113 and another end extending outside the case 10. When any one of the combination rings 113 is not being moved to a preset location, the movable strut 111 is latched by the combination rings 113 without moving. Only when all the combination rings 113 are turned to the correct and preset locations can the movable strut 111 be moved in the axial direction. Once the force applied to the movable strut 111 is absent, the elastic element 112 returns the movable strut 111 to its original position.

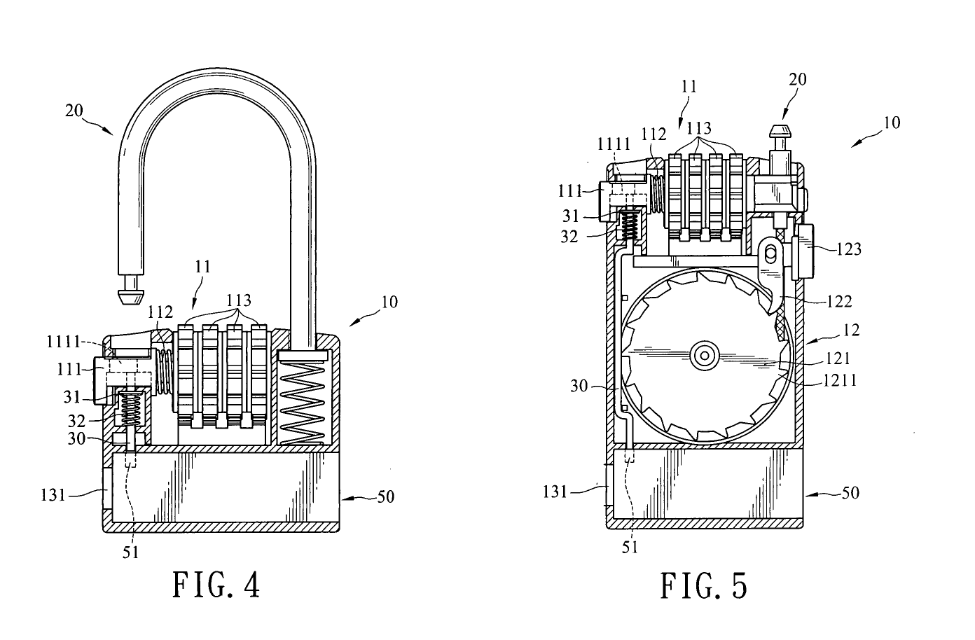

The first shackle 20 may be a flexible steel rope or cable, or a rigid member as shown in FIG. 4. It has two ends that may be coupled to the case 10 to form a latch position (as shown in FIG. 1B) and form a closed boundary with the case 10. It further can be latched by the bolt assembly 10 to form an anchor condition. In addition, the first shackle 10 may be separated from the case 10 to open the closed boundary at a release position (as shown in FIG. 1A).

The second shackle 30 is a rod movably located in the case 10, and may be moved to the first position to latch the second object 50 or the second position to release the second object 50. In this embodiment, the second shackle 30 is a rod, the first position is where the second shackle 30 has a portion being moved out of the case 10 (as shown in FIG. 1B), and the second position is where the second shackle 30 is located inside the case 10 (as shown in FIG. 1A). The second shackle 30 is coupled with an elastic element 32 to provide a returning force that keeps the second shackle 30 at the second position normally.

The second shackle 30 may be driven by the first shackle 20 to change position. When the second shackle 30 is at the second position, the case 10 and the second object 50 are coupled, and the first shackle 20 changes from the release position to the latch position, the second shackle 30 is driven to the first position and extended into a corresponding cavity 51 so that the second object 50 cannot be separated from the case 10. Meanwhile, the elastic element 32 is compressed by a boss 31.

Refer to FIG. 2 for a second embodiment of the invention. It also has a second shackle 30 driven by a first shackle 20. The first shackle 20 latches a first object, and the second shackle 30 latches a second object 50. For the first shackle 20 made of a flexible wire, the case 10 houses a winch 12 which includes a rotary wheel 121, a brake member 122 and an actuating member 123. The first shackle 20 has one end fastened to the rotary wheel 121, and may be wound on the winch through the rotary wheel 121. The rotary wheel 121 has a plurality of ratchet teeth 1211 on the peripheral rim. The brake member 122 can be engaged with the ratchet teeth 1211 to provide a brake function, and is driven by the actuating member 123 so that the brake member 122 may be moved to latch the ratchet teeth 1211 and prevent the rotary wheel 121 from rotating, or be moved away from the ratchet teeth 1211 so that the rotary wheel 121 may rotate as desired.

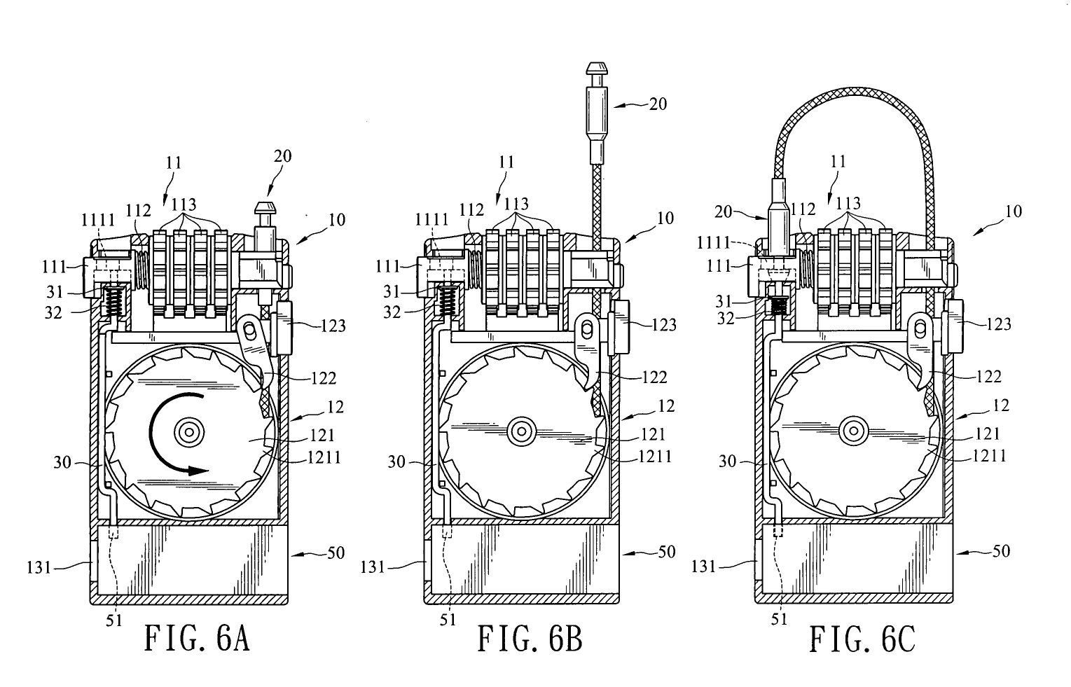

Referring to FIGS. 6A, 6B and 6C, the actuating member 123, aside from controlling the rotation of the rotary wheel 121, is anchored and not movable by the second shackle 30 at the first position. When the actuating member 123 is depressed to release the harness of the brake member 122 on the rotary wheel 121, the first shackle 20 may be pulled out from the rotary wheel 121. After the first shackle 20 has been pulled out for a selected length, the actuating member 123 may be released, the brake member 122 returns to the condition of engaging with the ratchet teeth 1211 to latch the rotary wheel 121, and the first shackle 20 that has been pulled out for a selected length from the case 10 is anchored. The pulled put end of the first shackle 20 may pass through an opening 1111 formed on the movable strut 111 to be latched by the bolt assembly 11. While the first shackle 20 is moved to the latch position, the second shackle 30 is driven and moved to the first position to latch the second object 50 coupled with the case. In addition, when the second shackle 30 reaches the first position, the actuating member 123 is stopped by the second shackle 30 and cannot be moved.

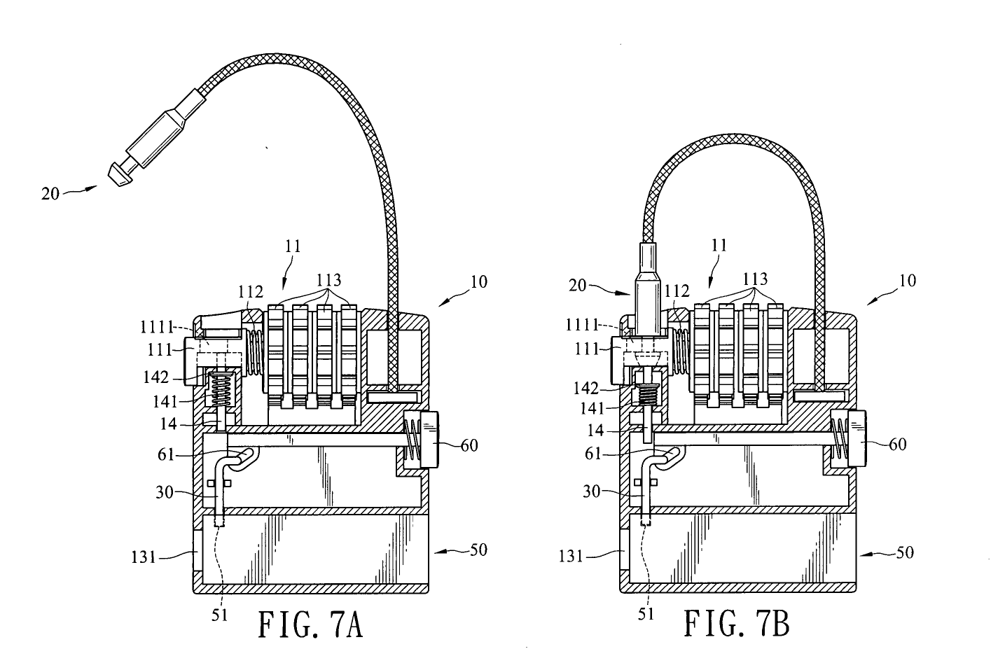

Refer to FIGS. 7A and 7B for yet another embodiment of the invention. It mainly has a retaining member 14 driven by the first shackle 20 at the latch position. The second shackle 30 is located at a position not movable by the first shackle 20, and has a portion extending outside the case 10 at the first position normally. When the first shackle 20 is at the latch position, the second shackle 30 may be driven through the retaining member 14 so that the second shackle 30 cannot be moved to the second position to release the second object 50, and the coupled case 10 and the second object 50 cannot be separated.

When the first shackle 20 is moved away from the latch position, the second shackle 30 is released from the retaining member 14 and becomes freely movable.

In the embodiment set forth above, when the first shackle 20 is at the latch position and latched by the bolt assembly 11, the retaining member 14 is depressed and extended to harness the second shackle 30. The elastic element 141 coupled on the boss 142 of the retaining member 14 is compressed. On the other hand, when the first shackle 20 is at the release position, the retaining member 14 releases the movement restriction of the second shackle 30, and the elastic element 141 also provides an elastic force to return the retaining member 14 to the position not harnessing the movement of the second shackle 30.

Moreover, one end of the second shackle 30 may be fastened to a guiding slot 61 of an actuating member 60 to form a chain movement. Thereby the second shackle 30 may be moved to the first position or the second position through the actuating member 60.

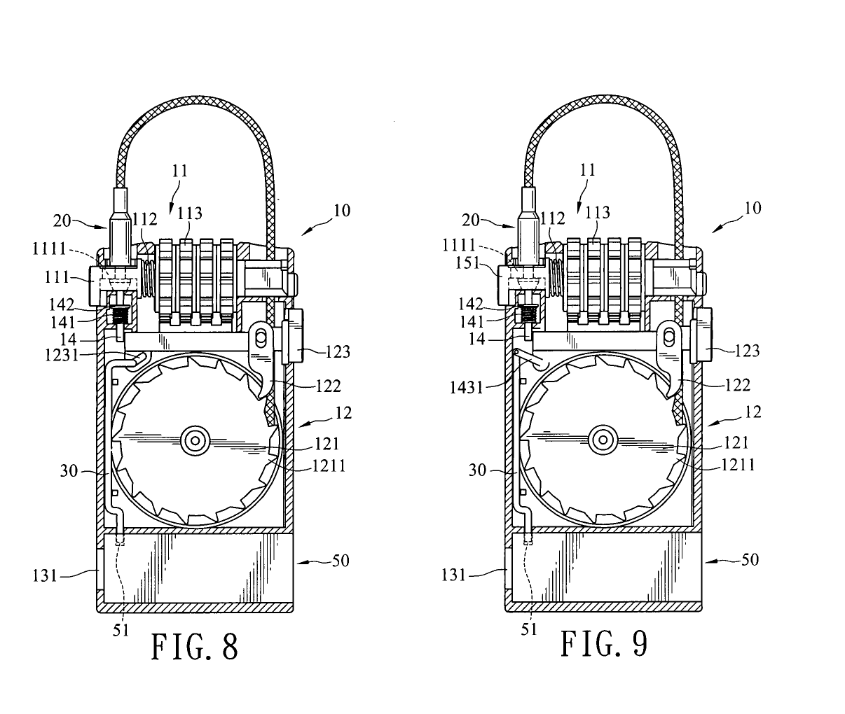

Refer to FIG. 8 for a fourth embodiment of the invention. In this embodiment, the actuating member 60 of the previous embodiment is replaced by an actuating member 123 of the winch 12. The actuating member 123 has a guiding slot 1231 to drive the second shackle 30 to change position.

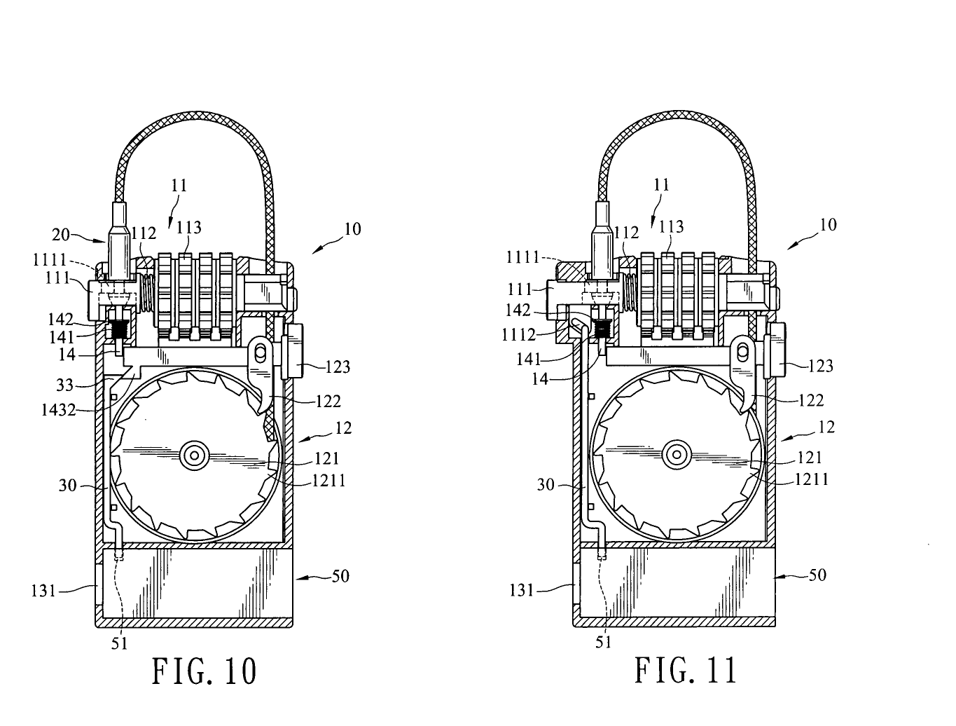

Referring to FIG. 9, the actuating member 123 set forth above may also be linked to the second shackle 30 through at least one linkage bar 1431 so that the second shackle 30 may be driven to change position by the actuating member 123 through the linkage bar 1431. Furthermore, the linking condition between the actuating member 123 and the second shackle 30 may also adopt that shown in FIG. 10. The actuating member 123 and the second shackle 30 have mating wedge sections 1432 and 33 that have sloped surfaces to achieve the desired linkage movement.

Refer to FIG. 11 for yet another embodiment of the invention. In this embodiment, the actuating member 60 of the previous embodiment is replaced by the movable strut 111 of the bolt assembly 11. The movable strut 111 has a guiding slot 1112 to drive the second shackle 30 to change position.

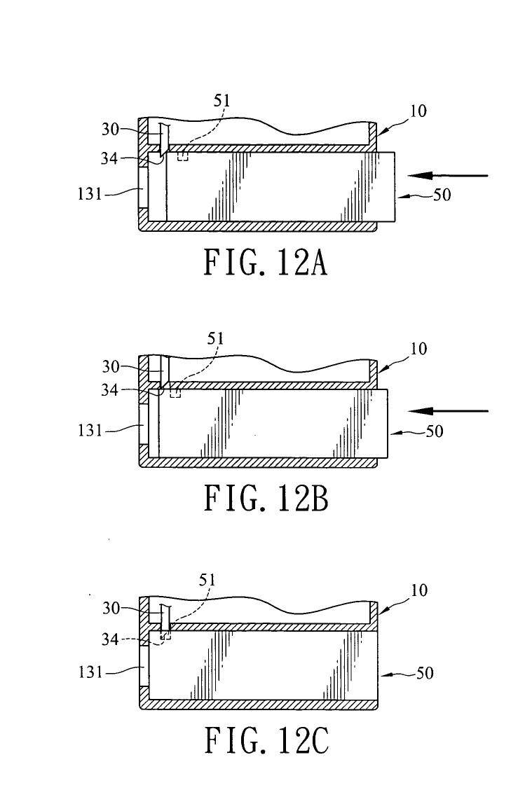

As previously noted, the second shackle 30 is at the first position normally with a portion thereof extending outside the case 10. The extended portion of the second shackle 30 may form a sloped surface 34, as shown in FIGS. 12A, 12B and 12C. Such a design enables the second object 50 to be slid inside the case 10 and pass over the sloped surface 34 of the second shackle 30 without impediment to complete assembly smoothly. After the second object 50 is coupled with the case 10, the second shackle 30 falls into the cavity 51 of the second object 50 to form a latch condition.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A lock mechanism for latching a first object then coupling with a second object, comprising:
a case having a bolt assembly;
a first shackle being selectively coupled with the case and forming a closed boundary with the case to latch the first object at a latch position and unfastening the closed boundary at a release position, and being latched and anchored by the bolt assembly at the latch position; and
a second shackle movably mounted on the case at a first position to latch the second object and at a second position to release the latching of the second object, and being at the second position normally and driven by the first shackle to change the positions.

2. The lock mechanism of claim 1, wherein the first shackle has two end coupling on the case at the latch position, and has at least one end separating from the case at the release position.

3. The lock mechanism of claim 1, wherein the first shackle is flexible.

4. The lock mechanism of claim 1, wherein the first shackle is rigid.

5. The lock mechanism of claim 1, wherein the case further has an elastic element to provide a returning force to keep the second shackle at the second position normally.

6. The lock mechanism of claim 1, wherein the case has a cartridge trough to house the second object.

7. The lock mechanism of claim 1, wherein the case and the second object have respectively a mating coupling interface for coupling with each other by latching.

8. The lock mechanism of claim 1, wherein the case and the second object have respectively a mating coupling interface for coupling with each other by sliding.

9. The lock mechanism of claim 1, wherein the case further has a winch and an actuating member for controlling movements of the winch, the actuating member being harnessed by the second shackle at the first position.

10. A lock mechanism for latching a first object then coupling with a second object, comprising:
a case having a bolt assembly;
a first shackle being selectively coupled with the case and forming a closed boundary with the case to latch the first object at a latch position and unfastening the closed boundary at a release position, and being latched and anchored by the bolt assembly at the latch position; and
a second shackle movably mounted on the case at a first position to latch the second object and at a second position to release the latching of the second object, and being at the first position normally, and being movable when the first shackle is moved to the release position.

11. The lock mechanism of claim 10, wherein the second shackle is a rod which has a distal end forming a sloped surface.

12. The lock mechanism of claim 10, wherein the second shackle is located in the case at the second position, and extended outside the case at the first position normally.

13. The lock mechanism of claim 10, wherein the case has a retaining member driven by the first shackle such that the retaining member constrains the second shackle from moving when the first shackle is at the latch position, and the retaining member does not constrain the second shackle from moving when the first shackle is at the release position.

14. The lock mechanism of claim 13, wherein the case includes an elastic element which keeps the retaining member from constraining the second shackle normally, and moves the retaining member to its original position when the first shackle releases the retaining member from moving constraint.

15. The lock mechanism of claim 13, wherein the case includes an actuating member for driving the second shackle to move to the latch position and the release position, and being harnessed by the retaining member without moving the second shackle when the first shackle is at the latch position.

16. The lock mechanism of claim 15, wherein the actuating member includes a guiding slot for connecting to one end of the second shackle.

17. The lock mechanism of claim 15, wherein the actuating member includes at least one linkage bar for connecting to the second shackle.

18. The lock mechanism of claim 15, wherein the actuating member has a wedge end, and the second shackle has a wedge section corresponding to the wedge end.

19. The lock mechanism of claim 15, wherein the case has a winch controlled by the actuating member.
